(19) United States
(12) Patent Application Publication
(10) Pub. No.: US 2026/0023196 A1
(43) Pub. Date: Jan. 22, 2026

(54) IMPACT-RESISTANT EYEGLASSES WITH TORIC LENS AND IMPACT-RESISTANT LENS

(71) Applicant: ALAN-SAFETY CO., LTD., TAINAN CITY (TW)

(72) Inventor: MING-HSIANG TSAI, TAINAN CITY (TW)

(73) Assignee: ALAN-SAFETY CO., LTD., TAINAN CITY (TW)

(21) Appl. No.: 19/038,619

(22) Filed: Jan. 27, 2025

(30) Foreign Application Priority Data
Jul. 18, 2024 (TW) 113126863

(51) Int. Cl. G02B 3/06; G02C 3/00; G02C 5/00; G02C 5/12; G02C 5/14; G02C 7/02

(52) U.S. Cl. CPC G02B 3/06; G02C 3/003; G02C 5/001; G02C 5/12; G02C 5/14; G02C 7/02

(57) ABSTRACT

The present invention relates to impact-resistant eyeglasses with toric lens and an impact-resistant lens. The impact-resistant eyeglasses with toric lens comprise at least one attaching unit and a lens unit. The attaching unit comprises at least one attaching portion extending a predetermined length along with a first linear direction. The lens unit comprises at least one assembling portion and at least one impact-resistant lens fixed to the assembling portion. The impact-resistant lens is symmetrically assembled with the attaching unit to a symmetric line through the assembling unit. Each impact-resistant lens comprises at least one curved area extending along two linear directions respectively. The curved area is bent with different curvatures along the two linear directions. The curvature of the curved area along one of the linear directions falls within 6˜7 curve, and the curvature of the curved area along another linear direction falls within 3˜3.8 curve.

### FIELD OF THE INVENTION

The present invention generally relates to eyeglasses and a lens thereof, and specifically, impact-resistant eyeglasses and an impact-resistant lens thereof.

### BACKGROUND OF THE INVENTION

To meet a specific requirement, such as participation for various types of activity or consideration of safety in a workplace, people need to wear goggles or eyeglasses protecting eyes from physical impacts or spattering, emitting or splashing objects, such as chemicals or particles. Such goggles or eyeglasses will provide a toughness to a certain extent within a certain covering range. However, the greater the covering range is, the more impacts and objects they will block. Therefore, how to design goggles or eyeglasses with a greater covering range and a better endurance against impact and objects is a target of the industry.

### SUMMARY OF THE INVENTION

One aspect of the present invention is to provide impact-resistant eyeglasses and an impact-resistant lens thereof which provide a better toughness within a greater covering range at an inner, outer, upper and lower side through bending a curved area extending two linear directions with two different curvatures along the linear directions, thereby promoting both the toughness and covering range. Preferably, the impact-resistant eyeglasses and impact-resistant lens thereof according to the present invention may be used in safety glasses with strengthen impact resistance and endurance.

Another aspect of the invention is to provide impact-resistant eyeglasses and an impact-resistant lens thereof which provide wide vision and comfortable wearing feeling through bending the curved area with a greater curvature along a horizontal direction, among the linear directions, thereby increasing the covering range in the inner and outer sides.

According to the present invention, the impact-resistant eyeglasses comprises at least one attaching unit and a lens unit. The attaching unit comprises at least one attaching portion extending a predetermined length along with a first linear direction. The lens unit comprises at least one assembling portion and at least one impact-resistant lens fixed to the assembling portion. The impact-resistant lens is symmetrically assembled with the attaching unit to a symmetric line through the assembling unit. Each impact-resistant lens comprises at least one curved area extending along two linear directions respectively. The curved area is bent with different curvatures along the two linear directions. The curvature of the curved area along one of the linear directions falls within 6˜7 curves, and the curvature of the curved area along another linear direction falls within 3˜3.8 curves.

According to the present invention, the impact-resistant lens comprises at least one curved area. The at least one curved area, extended along first and second linear directions respectively, is bent with different curvatures along the two linear directions. The curved area comprises a first extending section and a second extending section adjacent to outside of the first extending section, the first extending section is adapted to block an impact from a front direction of the impact-resistant lens, the second extending section is adapted to block another impact from one of inner and outer directions of the impact-resistant lens. The curvature of the curved area along one of the linear directions falls within 6˜7 curves, and the curvature of the curved area along another linear direction falls within 3˜3.8 curves.

### BRIEF DESCRIPTION OF THE DRAWINGS

Various objects and advantages of the present invention will be more readily understood from the following detailed description when read in conjunction with the appended drawing, in which:

FIG. 1 shows a perspective view of impact-resistant eyeglasses according to a first embodiment of the invention;

FIG. 2 shows a perspective view of an impact-resistant lens according to a second embodiment of the invention;

FIG. 3 shows a perspective view of impact-resistant eyeglasses according to a third embodiment of the invention.

### DESCRIPTION OF EMBODIMENTS OF THE INVENTION

For a more complete understanding of the present disclosure and its advantages, reference is now made to the following description taken in conjunction with the accompanying drawings, in which like reference numbers indicate like features. Persons of ordinary skill in the art having the benefit of the present disclosure will understand other variations for implementing embodiments within the scope of the present disclosure, including those specific examples described herein. The drawings are not limited to specific scale and similar reference numbers are used for representing similar elements.

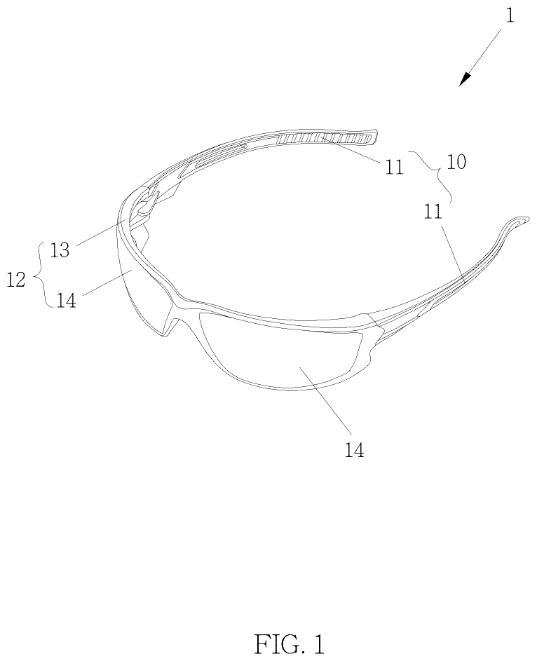

Reference is made to FIG. 1, which shows a perspective view of impact-resistant eyeglasses according to a first embodiment of the invention. Appearance, such as shape, sizes, ratio, etc. of impact-resistant eyeglasses 1, as shown in FIG. 1 is only for example, but not intended to limit the present invention. The impact-resistant eyeglasses 1 mainly comprises an attaching unit 10 and a lens unit 12. Materials of the attaching unit 10 and lens unit 12 are not limited; however, preferred materials comprise those having good toughness to promote impact-resistant performance of the impact-resistant eyeglasses 1. The toughness may be a comprehensive feature of strength and ductility. The attaching unit 10 is assembled with the lens unit 12, and optionally, the attaching unit 10 may be assembled with the lens unit 12 either with or without a pivot. With the pivot, the attaching unit 10 may be assembled with the lens unit 12 in a pivot connection, hinge connection, fastener connection, etc. Without the pivot, the attaching unit 10 may be assembled with the lens unit 12 in a molding process or in a strap and buckle fashion, in which the attaching unit 10 may be formed as a strap, etc. In the present embodiment, the attaching unit 10 is assembled with the lens unit 12 with the pivot, so as to allow rotation around the pivot to be a folded status facilitating storage and another rotation around the pivot to be a unfolded status facilitating usage.

In the present embodiment, the attaching unit 10 comprises two attaching portions 11 for a user to wear the impact-resistant eyeglasses 1. Exemplarily, the attaching portions 11 are two temples extending a predetermined length along a first linear direction respectively for wearing the impact-resistant eyeglasses 1 by hanging on cars of the users. In some other embodiments, attaching portions having a different structure or some more elements may be designed to promote stability, comfort, convenience and/or safety, etc. For example, the attaching portions may have a comfortable strap with an adjustable length which may be worn stably, or additional auxiliary support to increase safety. Preferably, these temples or two ends of the strap may be assembled on opposite sides of the impact-resistant eyeglasses 1 symmetrically.

The lens unit 12 comprises at least one assembling portion 13 and at least one impact-resistant lens 14; here, two impact-resistant lenses 14 for example. The assembling portion 13 may be, but not limited to, a frame. The impact-resistant lenses 14 may be a polarized lenses having a curved surface, such as toric lenses. Shape, sizes and ration of the impact-resistant lenses 14 may be exemplary and not intended to limit the present invention. The assembling portion 13 may be assembled with at least a corresponding portion of the impact-resistant lenses 14 in a wedging, squeezing or fixing manner, so as to fix the impact-resistant lenses 14 on the assembling portion 13. As such, through the assembling portion 13, the impact-resistant lenses 14 may be assembled with the attaching unit 10 symmetrically to a center line. In other words, in the present embodiment, when the two impact-resistant lenses 14 are fixed on the assembling portion 13 and assembled with the attaching unit 10, the impact-resistant lenses 14 and the attaching unit 10, as a whole, are symmetrical to the center line. Each impact-resistant lens 14 comprises a curved area extending along a second linear direction and a third linear direction respectively. The curved area is bent with different curvature along the second and third linear directions, and preferably, the curved area is a toric surface. The second linear direction may be, but not limited to, a horizontal direction perpendicular to the center line. The third linear direction may be, but not limited to, a vertical direction parallel to the center line. The first, second and third linear directions may be, but not limited to, a straight line direction, curved line direction or other type of linear direction. By setting different curvatures along different linear direction, for example, setting a smaller curvature along the second linear direction than that along the third linear direction, or setting a greater curvature along the second linear direction than that along the third linear direction, etc., the curved area of the impact-resistant lens 14 may be bent to a different extent in different directions, so as to increase toughness within a greater covering range at an inner, outer, upper and lower side of the impact-resistant lens 14. As such, impact resistance and endurance of the impact-resistant eyeglasses 1 may be strengthened. Preferably, the curvature of the curved surface along the second linear direction is less than that along the third linear direction, so as to adjust the toughness within the covering range at the inner, outer, upper and lower side of the impact-resistant lens 14. These sides of the impact-resistant lens 14 may be around a user's eyes and/or outer face when the impact-resistant eyeglasses 1 is worn by the user. Therefore, such arrangements facilitate blocking physical impacts and/or spattering, emitting or splashing objects and providing a wide vision and comfortable wearing feeling. More preferably, a radius of curvature of the curved area along the second linear direction falls within 87˜74 mm, 82˜86 mm here, and a radius of curvature of the curved area along the third linear direction falls within 174˜137.6 mm, 174˜149 mm here. The curvatures of the curved area may be calculated by dividing an optical constant Φ523 by the corresponding radius of curvature. The calculated curvature of the curved area along the second linear direction is about 6˜7 curves, and 6.081˜6.378 is preferred. The calculated curvature of the curved area along the third linear direction is about 3˜3.8 curves, and 3˜3.5 is preferred. The impact-resistant eyeglasses 1 may be safety glasses in compliance with a certain standards, such as ANSI safety standards, CSA safety compliance, AS/NZ standards, EN standards or military standard. This may be proved by testing results of impact resistance of the impact-resistant lens 14 or impact-resistant eyeglasses 1 under an impact of an object a speed of which reaches 42˜725 FT/S.

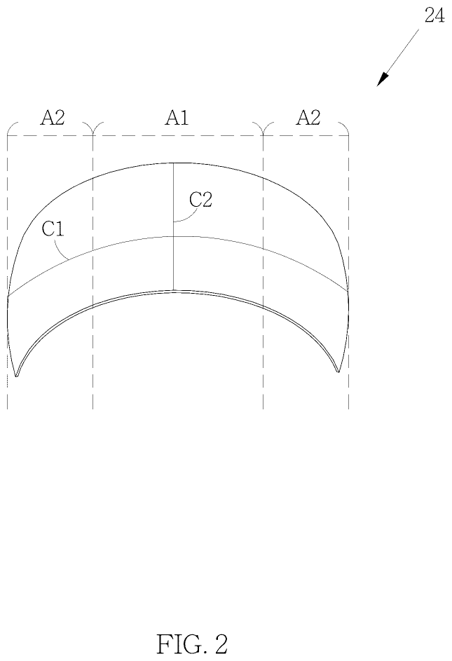

Reference is made to FIG. 2 which shows a perspective view of an impact-resistant lens according to a second embodiment of the invention. As shown in FIG. 2, an impact-resistant lens 24 may be provided to assemble in impact-resistant eyeglasses. Shape of an outer rim of the impact-resistant lens 24 or impact-resistant eyeglasses may be varied to meet an requirement, and are not intended to be limited to the figure. The impact-resistant lens 24 comprises a curved area extending along a first linear direction and a second linear direction respectively. The impact-resistant lens 24 of the present embodiment may be a toric lens for example. Aforesaid first and second linear directions may be straight line directions, curved line directions or other type of linear directions. The curved area is bent with different curvatures C1, C2 along the first and second linear directions, i.e. C1 may be less than C2 or C1 may be greater than C2. Here, C1 is less than C2 for example. Preferably, the curved area is a toric surface. Specifically, the curved area may comprise a first extending section A1 and two second extending sections A2 adjacent to inner side and outer side of the first extending section A1 in the first linear direction. The first extending section A1 may be adapted to block an impact from a front direction of the impact-resistant lens 24, and the second extending sections A2 may be adapted to block an impact from one of inner side and outer side directions of the impact-resistant lens 24. Because the curved area of the impact-resistant lens 24 is bent with different curvature along the first and second linear directions, toughness of the impact-resistant lens 24 within a covering range in the first and second linear directions will be increased to strengthen impact resistance and endurance of the impact-resistant eyeglasses.

Preferably, in the present embodiment, the first and second linear directions are perpendicular to each other, and horizontal and vertical directions respectively with reference to axes of the impact-resistant eyeglasses. In the curved area, the curvature C1 along the first linear direction, a horizontal direction, is different from the curvature C2 along the second linear direction, a vertical direction. For example, the curvature C1 along the horizontal direction may be less than the curvature C2 along the vertical direction, or the curvature C1 along the horizontal direction may be greater than the curvature C2 along the vertical direction. Here, the curvature C1 along the horizontal direction is greater than the curvature C2 along the vertical direction for example. As such, the curved area is bent to a greater extent along the horizontal direction than along the vertical direction to meet transition shape from a front face to a side face of a user. Then, toughness of the impact-resistant lens 24, as well as the covering range covering right and left sides of an eye area around user's eyes may be promoted to strengthen impact resistance against an impact from a lateral direction and endurance of the impact-resistant eyeglasses and provide wide vision and comfortable wearing feeling. Preferably, a radius of curvature of the curved area along the second linear direction falls within 87˜74 mm, and more preferably, 82˜86 mm, and a radius of curvature of the curved area along the third linear direction falls within 174˜137.6 mm, and more preferably, 174˜149 mm. The curvatures of the curved area may be calculated by dividing an optical constant Φ523 by the corresponding radius of curvature. The calculated curvature of the curved area along the second linear direction is about 6˜7 curves, and 6.081˜6.378 is preferred. The calculated curvature of the curved area along the third linear direction is about 3˜3.8 curves, and 3˜3.5 is preferred. The impact-resistant eyeglasses 1 may be safety glasses in compliance with a certain standards, such as ANSI safety standards, CSA safety compliance, AS/NZ standards, EN standards or military standard. This may be proved by testing results of impact resistance of the impact-resistant lens 14 or impact-resistant eyeglasses 1 under an impact of an object a speed of which reaches 42˜725 FT/S.

In another embodiment, in which the curvature C1 along the horizontal direction is less than the curvature C2 along the vertical direction, the curved area is bent to a greater extent along the vertical direction than along the horizontal direction to cover upper and lower area of a user's eyes. Then, toughness of the impact-resistant lens, as well as the covering range covering an eye area around the upper and lower area of the user's eyes may be promoted to strengthen impact resistance against an impact from one of upper and lower directions and endurance of the impact-resistant eyeglasses. The impact-resistant lens of the present embodiment is equivalent to the impact-resistant lens 14 of the embodiment but with 90 degrees rotation. Here, the curved area may comprise a first extending section and two second extending sections adjacent to upper side and lower side of the first extending section. The first extending section may be adapted to block an impact from a front direction of the impact-resistant lens, and the second extending sections A2 may be adapted to block an impact from one of upper side and inner side directions of the impact-resistant lens.

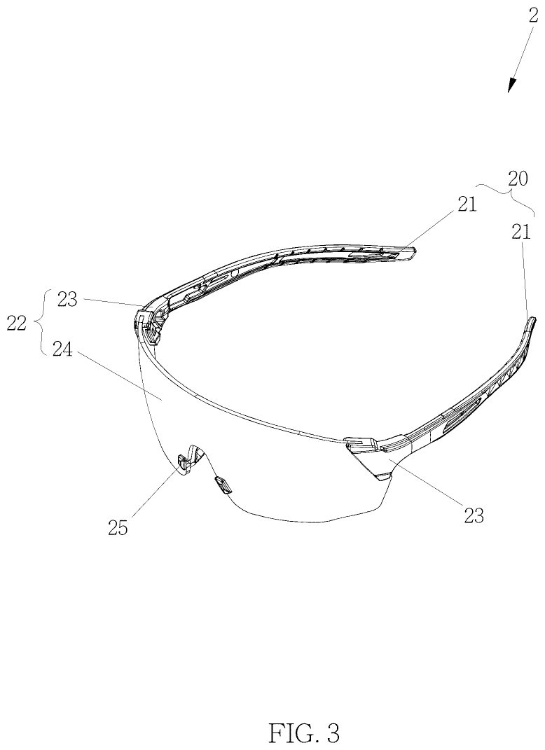

Reference now is made to both FIGS. 2 and 3. FIG. 3 shows a perspective view of impact-resistant eyeglasses according to a third embodiment of the invention. Appearance, such as shape, sizes, ratio, etc. of impact-resistant eyeglasses 2, as shown in FIG. 3 is only for example, but not intended to limit the present invention. The impact-resistant eyeglasses 2 mainly comprises an attaching unit 20, a lens unit 22 and a nose pad unit 25. Materials of the attaching unit 10, lens unit 22 and nose pad unit 25 are not limited; however, preferred materials comprise those having good toughness to promote impact-resistant performance of the impact-resistant eyeglasses 2. The toughness may be a comprehensive feature of strength and ductility. The attaching unit 20 is assembled with the lens unit 22, and optionally, the attaching unit 20 may be assembled with the lens unit 22 either with or without a pivot. With the pivot, the attaching unit 20 may be assembled with the lens unit 22 in a pivot connection, hinge connection, fastener connection, etc. Without the pivot, the attaching unit 20 may be assembled with the lens unit 22 in a molding process or in a strap and buckle fashion, in which the attaching unit 20 may be formed as a strap, etc. In the present embodiment, the attaching unit 20 is assembled with the lens unit 22 with the pivot, so as to allow rotation around the pivot to be a folded status facilitating storage and another rotation around the pivot to be a unfolded status facilitating usage.

In the present embodiment, the attaching unit 20 comprises two attaching portions 21 for a user to wear the impact-resistant eyeglasses 2. Exemplarily, the attaching portions 21 are two temples extending a predetermined length along a first linear direction respectively for wearing the impact-resistant eyeglasses 2 by hanging on cars of the users. In some other embodiments, attaching portions having a different structure or some more elements may be designed to promote stability, comfort, convenience and/or safety, etc. For example, the attaching portions may have a comfortable strap with an adjustable length which may be worn stably, or additional auxiliary support to increase safety. Preferably, these temples or two ends of the strap may be assembled on opposite sides of the impact-resistant eyeglasses 2 symmetrically.

The lens unit 22 comprises at least one assembling portion 23 and at least one impact-resistant lens 24; here, an impact-resistant lens 24 of the second embodiment for example. The impact-resistant lens 24 may be a single lens having a curved surface, such as toric lenses. Shape, sizes and ration of the impact-resistant lenses 24 may be exemplary and not intended to limit the present invention. The assembling portion 23 may be, but not limited to, two connecting units connecting between the attaching unit 21 and the assembling portion 23. The assembling portion 23 may be assembled with at least a corresponding portion of the impact-resistant lens 24 in a wedging, squeezing or fixing manner, so as to fix the impact-resistant lens 24 on the assembling portion 23. As such, through the assembling portion 23, the impact-resistant lens 24 may be assembled with the attaching unit 20 symmetrically to a center line. In other words, in the present embodiment, when the impact-resistant lens 24 is fixed on the assembling portion 23 and assembled with the attaching unit 20, the impact-resistant lens 24 and the attaching unit 20, as a whole, are symmetrical to the center line, and the attaching unit 21, such as temples, strap, etc. is assembled at opposite sides of the center line respectively, so as to make the whole of the impact-resistant lens 24 and the attaching unit 20 symmetric to the center line.

The nose pad unit 25 is assembled with the lens unit 22 for wearing the impact-resistant eyeglasses 2 in a more stable way of attaching on a nose of the user.

As mentioned above, when using the impact-resistant lens 24 of the second embodiment, toughness of the impact-resistant lens 24, as well as the covering range covering the eye area around user's eyes may be promoted to strengthen impact resistance against an impact from the lateral direction and endurance of the impact-resistant eyeglasses. However, other impact-resistant lens, such as the impact-resistant lens 14 of the first embodiment, may be used here.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. Impact-resistant eyeglasses, comprising:
a attaching unit, comprising at least one attaching portion extending a predetermined length along a first linear direction; and
a lens unit, comprising at least one assembling portion and at least one impact-resistant lens, fixed to the assembling portion and symmetrically assembled with the attaching unit to a center line through the assembling unit,
wherein each of the at least one impact-resistant lens comprises at least one curved area extending along second and third linear directions respectively, the curved area is bent with different curvatures along the second and third linear directions, the curvature of the curved area along the second linear direction falls within 6˜7 curves, and the curvature of the curved area along the third linear direction falls within 3˜3.8 curves.

2. The impact-resistant eyeglasses according to claim 1, wherein the second linear direction is a horizontal direction perpendicular to the center line, and the second linear direction is a vertical direction parallel to the center line.

3. The impact-resistant eyeglasses according to claim 1, wherein the curved area comprises a first extending section and a second extending section adjacent to outside of the first extending section, the first extending section is adapted to block an impact from a front direction of the impact-resistant lens, and the second extending section is adapted to block another impact from one of inner and outer directions of the impact-resistant lens.

4. The impact-resistant eyeglasses according to claim 1, wherein the at least one impact-resistant lens is a toric lens.

5. The impact-resistant eyeglasses according to claim 1, wherein the lens unit comprises two impact-resistant lenses.

6. The impact-resistant eyeglasses according to claim 1, wherein the at least one assembling portion comprises a connecting unit connecting the attaching unit to the lens unit.

7. The impact-resistant eyeglasses according to claim 1, wherein the at least one assembling portion comprises two temples.

8. The impact-resistant eyeglasses according to claim 1, wherein the at least one assembling portion comprises a strap.

9. The impact-resistant eyeglasses according to claim 1, further comprising a nose pad unit assembled with the lens unit.

10. An impact-resistant lens, comprising:
at least one curved area, extending along first and second linear directions respectively and bent with different curvatures along the first and second linear directions;
wherein the curved area comprises a first extending section and a second extending section adjacent to outside of the first extending section, the first extending section is adapted to block an impact from a front direction of the impact-resistant lens, the second extending section is adapted to block another impact from one of inner and outer directions of the impact-resistant lens, the curvature of the curved area along the first linear direction falls within 6˜7 curves, and the curvature of the curved area along the second linear direction falls within 3˜3.8 curves.

11. The impact-resistant lens according to claim 10, wherein the first linear direction is a horizontal direction, the second linear direction is a vertical direction.

12. The impact-resistant lens according to claim 10, wherein the impact-resistant lens is a toric lens.
